(19) United States
(12) Patent Application Publication
(10) Pub. No.: US 2015/0150267 A1
(43) Pub. Date: Jun. 4, 2015

(54) APPARATUS FOR FORMING A FLAT-ROLLED CONTINUOUSLY CONVEYED DOUGH SHEET

(71) Applicant: HAAS FOOD EQUIPMENT GMBH, WIEN (AT)

(72) Inventors: Johannes Haas, Wien (AT); Josef Haas, Leobendorf (AT); Stefan Jiraschek, Koenigsbrunn (AT); Peter Lambauer, Hitzendorf (AT)

(21) Appl. No.: 14/406,278

(22) PCT Filed: Jun. 6, 2013
(86) PCT No.: PCT/EP2013/061656

§ 371 Date: Dec. 8, 2014

(30) Foreign Application Priority Data
Jun. 8, 2012 (AT) A 660/2012

(51) Int. Cl. A21C 3/02

(52) U.S. Cl. CPC A21C 3/02

(57) ABSTRACT

An apparatus for forming a flat-rolled continuously conveyed dough sheet has an upper roller and a lower roller. The upper roller is driven rotationally about a first axis of rotation and the lower roller is driven rotationally about a second axis of rotation. The direction of rotation of the upper roller is opposite to the direction of rotation of the lower roller. A roll nip is formed between the upper roller and the lower roller for guiding therethrough and rolling out the dough sheet. The rollers have a configuration which favors resting of the dough sheet on the lower roller and the axes of rotation of the two rollers can be inclined relative to one another.

The invention relates to an apparatus and an arrangement for forming a flat-rolled continuously conveyed dough sheet, comprising an upper roller which is driven rotationally about a first axis of rotation and a lower roller which is driven rotationally about a second axis of rotation, wherein the direction of rotation of the upper roller is opposite to the direction of rotation of the lower roller, and wherein between the upper roller and the lower roller, a roller nip is provided for guiding through and rolling out the dough sheet.

The field of the invention relates to the manufacture of flat-rolled continuously conveyed dough sheets such as, for example, for the industrial production of biscuits. For this purpose, dough coming from a mixer and an apparatus for the coarse pre-preparation of the dough sheet is fed via a conveyor belt to a rolling mill. According to the prior art, this comprises a roller pair of two counteracting rollers. Between the rollers, a certain roller nip is kept free, which serves to guide through the dough sheet and roll out the dough. Since the thinning of the dough per roller pair is limited, a plurality of roller pairs can be arranged in series one behind the other. The thin, continuous dough sheet is then fed, for example, to a cutting-out device. The individual cut-out biscuit dough pieces are subsequently transferred to the baking belt of a baking machine, baked and optionally packed.

Roll mills corresponding to the prior art, which are also known in technical circles under the term “Duomat”, comprise two rollers connected substantially rigidly to a machine frame. Both rollers have the same diameter and are driven about parallel-running axes in opposite directions of rotation. Optionally one of the two rollers is displaceable parallel by means of an adjusting device so that the gap width can be adjusted.

A disadvantage with this construction is that particularly when rolling out very thinly, the dough sheet tends to tear during release from one of the two rollers. The risk of damage to the dough sheet tends to be increased since the dough sheet has thinner and thicker regions due to positional and shape tolerances of the rollers. During rolling, the rollers are pressed with a certain pressure onto the dough sheet. Under this pressure, the rollers become deformed with the result that the dough sheet has a greater thickness in the middle than in the edge zone. In order to prevent bending of the rollers, the rollers according to the prior art have larger dimensions. The increase in the diameter increases the area moment of inertia of the rollers and therefore the resistance to bending. A disadvantage here is that as a result of the enlargement of the roller diameter, more material is required to produce the rollers. This is a cost factor which, for example, when using stainless steel, brings with it high financial disadvantages.

Furthermore, when using two same-size rollers, the problem arises that the dough sheet adheres approximately equally strongly to the lower and to the upper roller. Thus, when leaving the roller nip, the sheet is not given any stable direction of emergence. This can lead to oscillating movement of the emerging sheet and in turn lead to destruction. In order to make the sheet adhere to the lower roller, according to the prior art an attempt is made to assist release from the upper roller by means of air nozzles. This is also disadvantageous for the quality of the dough sheet formed.

It is now the object of the invention to overcome the disadvantages of the prior art and provide a device for forming a flat-rolled continuously conveyed dough sheet, which is favourable to manufacture, favourable to operate, low-maintenance in operation and which furthermore is suitable for producing a higher-quality dough sheet.

The objects according to the invention are solved whereby the rollers have a configuration which favours resting of the dough sheet on the lower roller and that the axes of rotation can be inclined relative to one another.

Further features according to the invention are that the upper roller has a smaller diameter than the lower roller, that the upper roller has a higher circumferential speed than the lower roller and/or that the axes of rotation optionally run parallel or skew with respect to one another, optionally have no point of intersection or a common point of intersection, can be crossed and/or tilted with respect to one another.

It can advantageously be provided that the upper roller or a first shaft coupled to the upper roller is mounted at a first bearing point on a first bearing and at a second bearing point on a second bearing, and that the two bearings are designed as radial bearings; that the lower roller or a second shaft coupled to the lower roller is mounted at a third bearing point on a third bearing and at a fourth bearing point on a fourth bearing, and that the two bearings are designed as radial bearings; the bearings are coupled to a machine frame and/or that at least one bearing point is movable with respect to the other bearing points by means or one or more adjusting devices.

Further, the invention is for example characterised in that one or both bearing points of one of the two rollers are movable, that the adjusting device comprises an electrical or mechanical actuator for inclination of the axes of rotation and for movement of at least one bearing point, that the adjusting device is adapted for movement of at least one bearing point with respect to the machine frame or with respect to the remaining bearing points and/or that the adjusting device comprises a bearing block firmly connected to a bearing or a bearing point which is movable substantially linearly by means of an actuator with respect to the machine frame and/or with respect to another bearing point.

In the invention it can also be provided that the adjusting device comprises a first pivot arm which is coupled rotatably about a first pivot axis to the machine frame, that one of the bearing points and a relevant bearing is provided on the first pivot arm and that the first pivot arm and the bearing point provided on the pivot arm are movable by means of a first actuator; that the first pivot arm is mounted in the machine frame by means of a first pivot bearing and that the position of the first pivot bearing with respect to the machine frame is variable, wherein the position is preferably variable in a normal plane of the first pivot axis, that the adjusting device comprises a second pivot arm which is coupled rotatably about a second pivot axis to the machine frame, that one of the bearing points and a relevant bearing is provided on the second pivot arm and that the second pivot arm and the bearing point provided on the second pivot arm are movable by means of the second actuator; that the second pivot arm is mounted in the machine frame by means of a second pivot bearing and that the position of the second pivot bearing with respect to the machine frame is variable, wherein the position is preferably variable in a normal plane of the second pivot axis; that the axis of rotation of one roller can be inclined with respect to the second axis of rotation by movement of the bearing or bearing points provided in the pivot arms; that at least one of the two pivot arms is movable relative to the other pivot arm and/or that the two pivot arms are movable independently of one another.

The invention further relates to an arrangement to form an endless flat-rolled continuously conveyed dough sheet characterised in that two or more devices according to the preceding and the following description are provided along the dough sheet.

The arrangement is preferably characterised in that the gap width of at least one roller nip of one device is smaller than the gap width of a downstream device in the direction of transport of the dough sheet, that the adjusting devices of the individual devices are controllable and/or movable separately from one another, that a control unit is provided for controlling the drives, the conveyance along the conveying surfaces and/or the adjusting devices and/or that the control unit is connected to a control unit of the baking machine or that one control unit is provided for controlling the arrangement and the baking machine.

The apparatus according to the invention comprises an upper roller and a lower roller. These are preferably both driven rotationally. The drive of the two rollers can be accomplished by two separate rotational drives. Another possibility for driving both rollers is the provision of a drive which drives both rollers via a transmission. In order to nevertheless be able to control the circumferential speeds of both rollers separately, the transmission can for example have selectable gear transmission ratios. This can be achieved, for example, by a continuously variable transmission for the transmission of one of the two rollers. The two rollers have a different direction of rotation. For the conveyance and rolling of the dough sheet, the two rollers each rotate in one direction so that the side of the rollers facing the roller nip is moved in the direction of transport of the dough sheet. Since the rollers are arranged on both sides of the gap, the direction of rotation of the two rollers must be opposite for this purpose. Furthermore, the rollers have a configuration which favours resting of the dough sheet on the lower roller. This includes, for example, that the dynamic adhesion tendency of the dough sheet to the lower roller is greater than that on the upper roller. Thus the apparatus is configured in such a manner that the dough sheet is released more easily from the upper roller than from the lower roller. As a result, on emerging from the roller nip, the dough sheet remains adhering to the lower roller and is only released from the lower roller after a certain distance in order to be conveyed further. In order to achieve this effect, a plurality of constructive features are provided according to the invention:

Thus, for example, the upper roller has a smaller diameter than the lower roller. In the roller nip both rollers touch the dough sheet. When the dough sheet emerges, the surfaces of both roller bodies move away from the dough sheet due to the rotation of the two rollers. Since the curvature of the upper roller is more strongly defined than the curvature of the lower roller, the upper roller moves away from the dough sheet more rapidly than the lower roller relative to the continued movement of the dough sheet. As a result of the inertia of the moving dough sheet, the release force between the upper roller and the dough sheet is therefore greater than the release force between the lower roller and the dough sheet. As a result of this dynamic effect, the dough sheet is released from the upper roller and remains adhering to the lower roller.

Alternatively or additionally, the upper roller has a higher circumferential speed than the lower roller. In the roller nip the dough sheet touches the lower roller on one side and the upper roller on its opposite side. The dough sheet here has a certain thickness which substantially corresponds to the gap width. If the circumferential speed of the upper roller is now greater than the circumferential speed of the lower roller, this higher speed is also applied to the upper side of the dough sheet. As a result of the different speed of the dough sheet on the upper and lower side, the dough sheet will be bent in the direction of the lower roller on emerging from the roller nip. This dynamic effect also contributes to promoting resting of the dough sheet on the lower roller.

A further constructive measure to promote resting on the lower roller is the vertical arrangement of the two rollers. Thus, the lower roller is provided according to its name below the upper roller. Gravity acts in this case on the moving dough sheet and pulls this in the direction of the lower roller.

According to the invention, the axes of rotation of the two rollers can be inclined with respect to one another. The inclination of the axes with respect to one another subsequently brings about an oblique position of the rollers with respect to one another, a crossing of the rollers with respect to one another and/or a mixed form of the two positions. The two axes can thus run parallel to one another, run skew to one another, be sloping so that they have a common point of intersection and/or lie crossed with respect to one another in two parallel planes.

As a result of the variation of the relative position of the two axes of rotation with respect to one another, the shape of the roller nip also changes. Due to an oblique position the roller nip has a substantially trapezoidal shape. As a result of the crossing of the axes of rotation relative to one another, the pressure of the two rollers on the dough sheet can be increased in that region in which the two rollers have the smallest normal distance from one another. Furthermore, as a result of the crossing of the axes of rotation on the one hand, the sagging of the rollers due to the pressure of the dough sheet can be reduced. On the other hand, the shape of the roller nip can be varied due to the crossing of the axes so that any sagging of the rollers is compensated and a dough sheet having constant thickness can be produced. The thickness of the emerging dough sheet can be influenced by the parallel displacement of the axes or by a reduction in the column width of the roller nip.

The apparatus comprises a machine frame. The two rollers are mounted in or on this machine frame. The upper roller thus has a first and a second bearing. These bearings are preferably design as rotary bearings and are coupled to the machine frame on both sides of the roller. Preferably a shaft or the roller itself is mounted in the bearings. The position of the bearings on the machine frame or on parts of an adjusting device is designated as bearing point.

The lower roller is disposed similarly. Thus, the lower roller is mounted on a third and on a fourth bearing. The two bearings are again designed as rotary bearings and are preferably disposed on both sides of the lower roller. The position of the bearings of the lower roller is also designated in each case as bearing point.

For inclination of the axes of rotation relative to one another, according to the apparatus according to the invention at least one bearing point can now be offset. At the same time, the position of the bearing point is moved with respect to the position of the other bearing points. Depending on the direction of the movement, a crossing or another movement of the rollers with respect to one another occurs in this case.

Preferably the bearing point is movable by actuating a mechanical or electrical actuator. Movement apparatus such as, for example, linear axes, driven axes of rotation, pneumatic cylinders, hydraulic cylinders, rack-and-pinion gears or similar devices can be considered for this purpose. These can preferably be controlled and/or regulated. However, it is also consistent with the inventive idea to provide a manual movement device such as, for example, a spindle adjustment.

Preferably the inclination of the axes of rotation relative to one another is possible during operation. Thus, during operation the shape and condition of the dough sheet can be adapted by varying the position of the axis of rotation.

Preferably both bearing points of a roller can be moved. By this means on the one hand the gap width and on the other hand the gap shape can be selected. The movement of one bearing point is preferably independent of the movement of the other bearing point of the roller. It should be noted here that the movement of the bearing points primarily serves to vary the roller nip.

The apparatus and arrangements according to the invention are preferably used “inline” in machines for the industrial production of baked goods such as, for example, biscuits. The production of the continuously conveyed dough sheet is therefore coupled and/or synchronised with other steps of the manufacturing process such as, for example the preparation of the dough, cutting out the dough sheet and/or baking the dough pieces.

Preferably the present apparatus and the arrangement of a plurality of apparatuses according to the invention comprise one control unit. This control unit is suitable for and/or adapted for controlling, regulating and/or synchronising parameters such as the rotational speed of the rollers, the transport speed along the transport surfaces, the movement of the adjusting device to vary the roller nip and/or the inclination of the axes of rotation of the rollers. To this end, a dedicated control unit can be provided per apparatus. Preferably however one control unit is provided which is adapted to control the entire arrangement and/or the baking machine. Thus, for example, one control unit can be provided which controls both the baking machine and also the apparatus according to the invention and the arrangement according to the invention. Alternatively to this, the arrangement according to the invention or the apparatus according to the invention can comprise one control unit which is connected to the control unit of a baking machine.

In this context, it is defined that an actuator substantially corresponds to a component which executes a controlled and/or a regulated movement. Examples for actuators are pneumatic drives such as pneumatic cylinders, hydraulic drives such as, for example, hydraulic pistons or hydraulic cylinders, electric drives, linear axes etc.

A sheet having a length of at least several metres is designated as endless dough sheet.

The invention is further described subsequently with reference to specific embodiments.

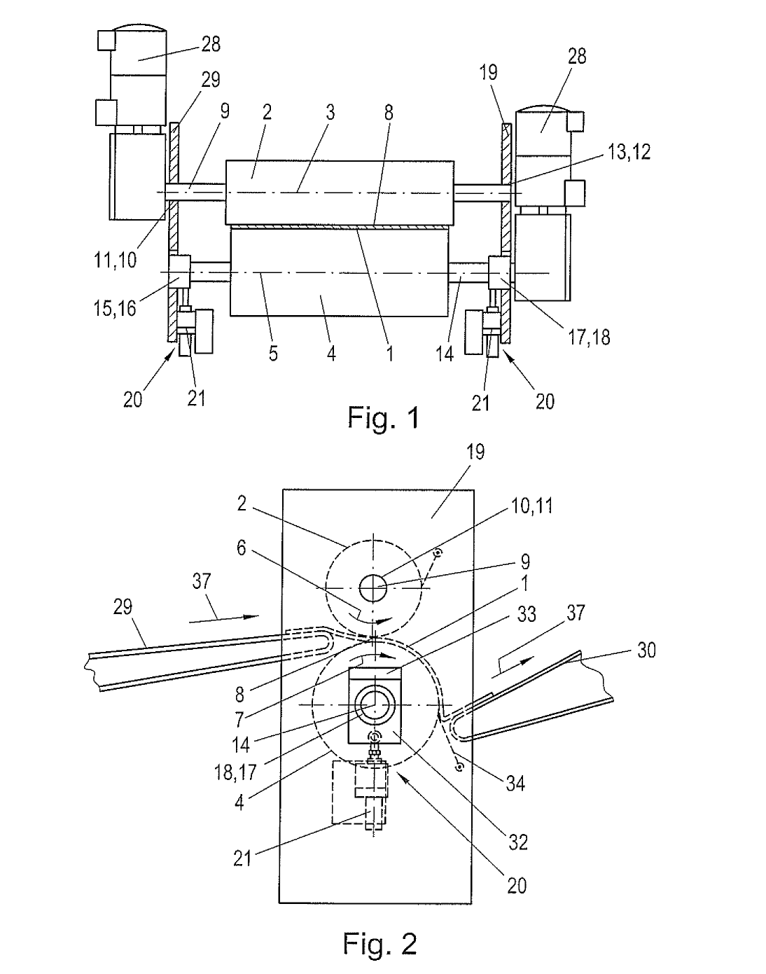

FIG. 1 shows a view of an apparatus according to the invention, where the viewing axis substantially follows the transport direction of the dough sheet.

FIG. 2 shows a schematic side view of one embodiment of the apparatus according to the invention.

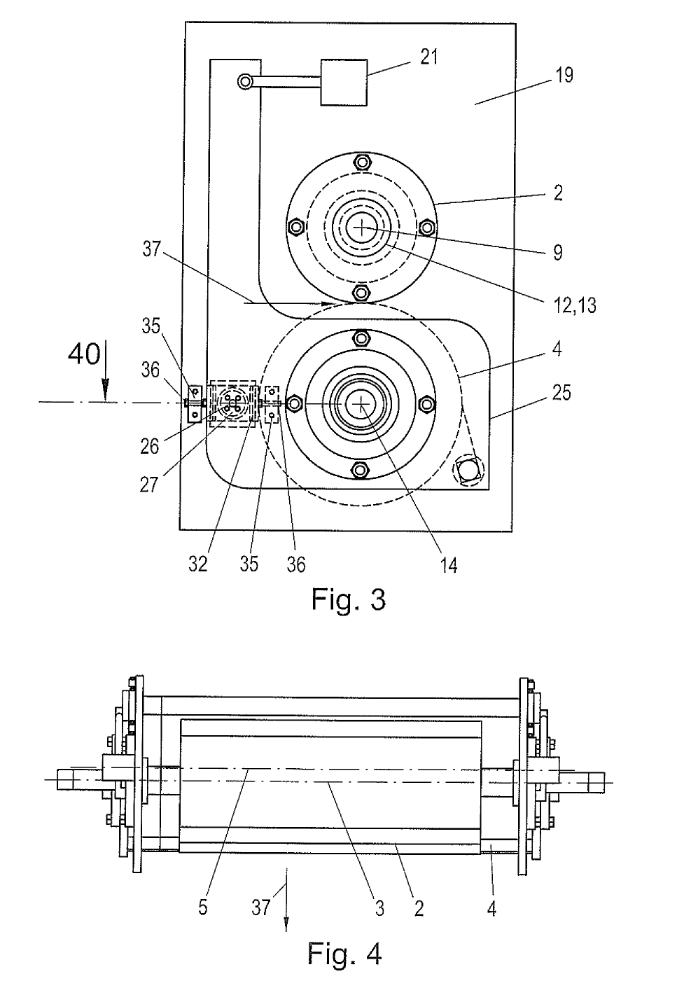

FIG. 3 shows a side view of a further embodiment of the apparatus according to the invention.

FIG. 4 shows a view of the apparatus according to the invention where the viewing line runs substantially normally to the conveying direction of the dough sheet.

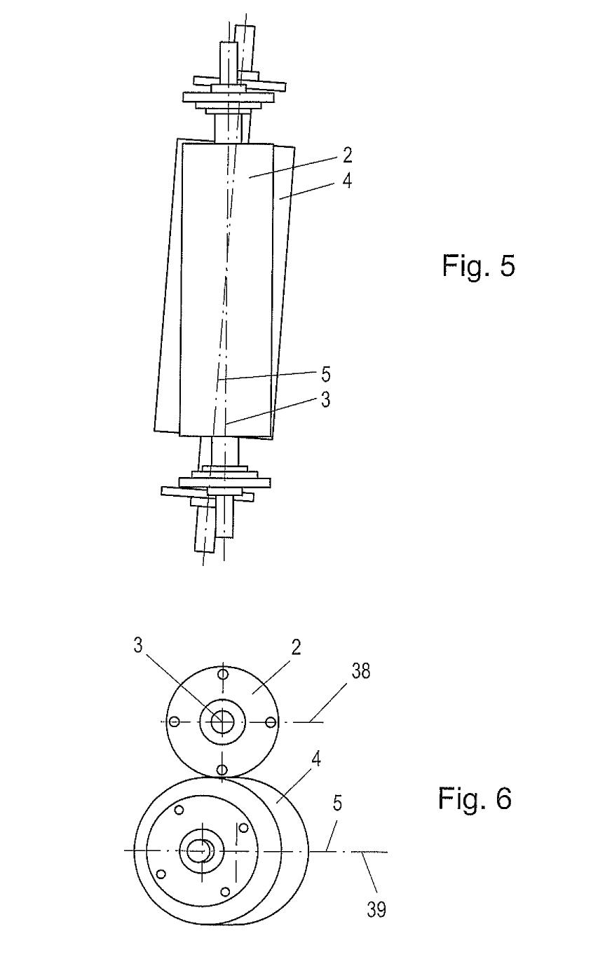

FIG. 5 shows a schematic view of two crossed rollers in a view from above.

FIG. 6 shows a schematic view of two crossed rollers in a side view.

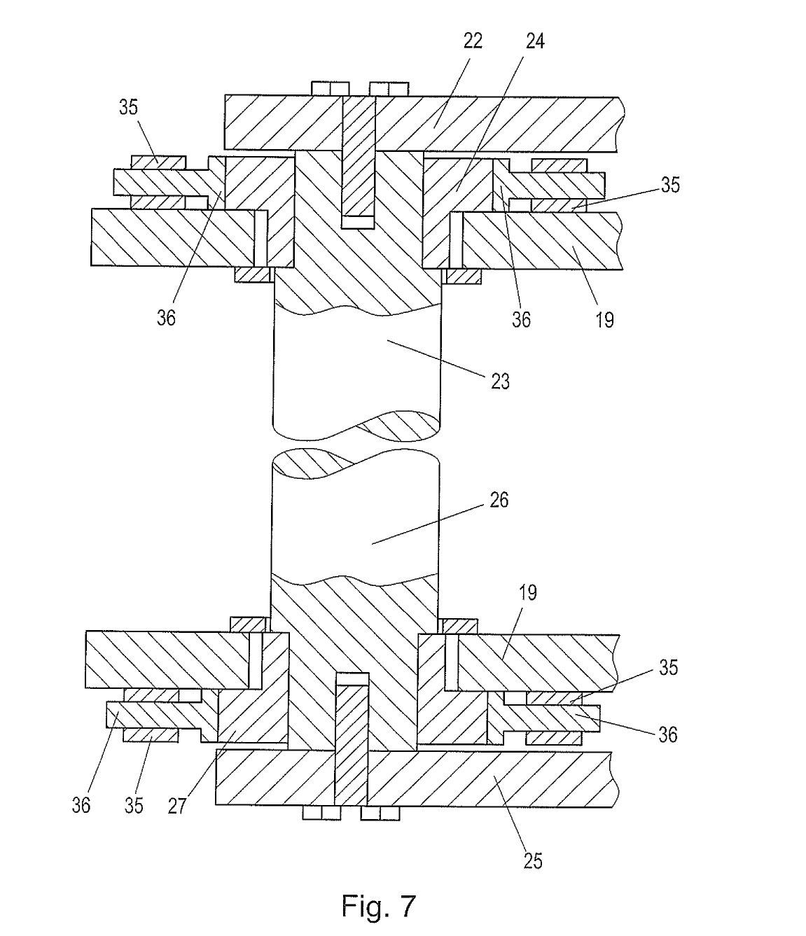

FIG. 7 shows a schematic sectional view of a detail of the pivot axis.

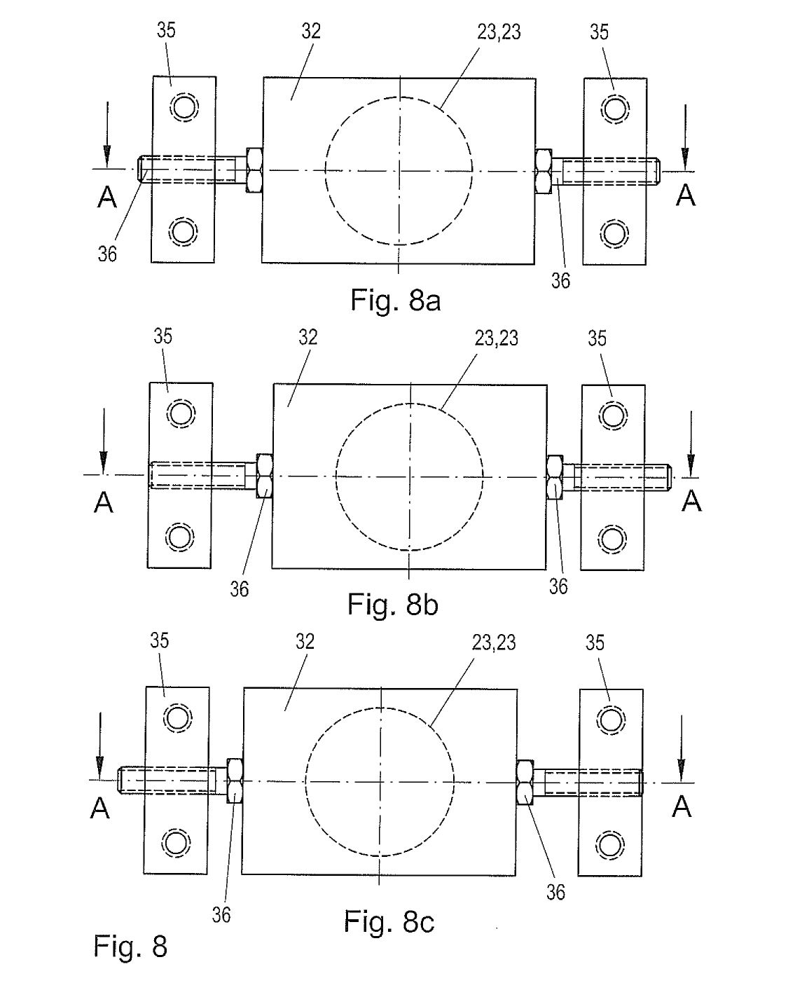

FIG. 8 shows three positions of the adjusting device.

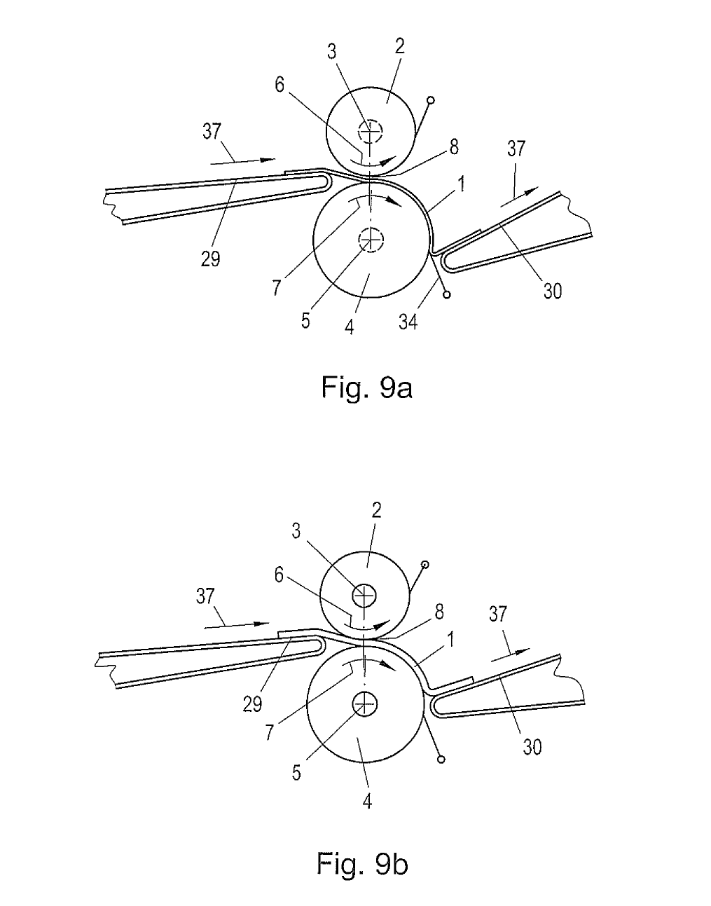

FIG. 9 shows a schematic view of an apparatus according to the invention with a dough sheet guided through, which is released from the lower roller by a stripper.

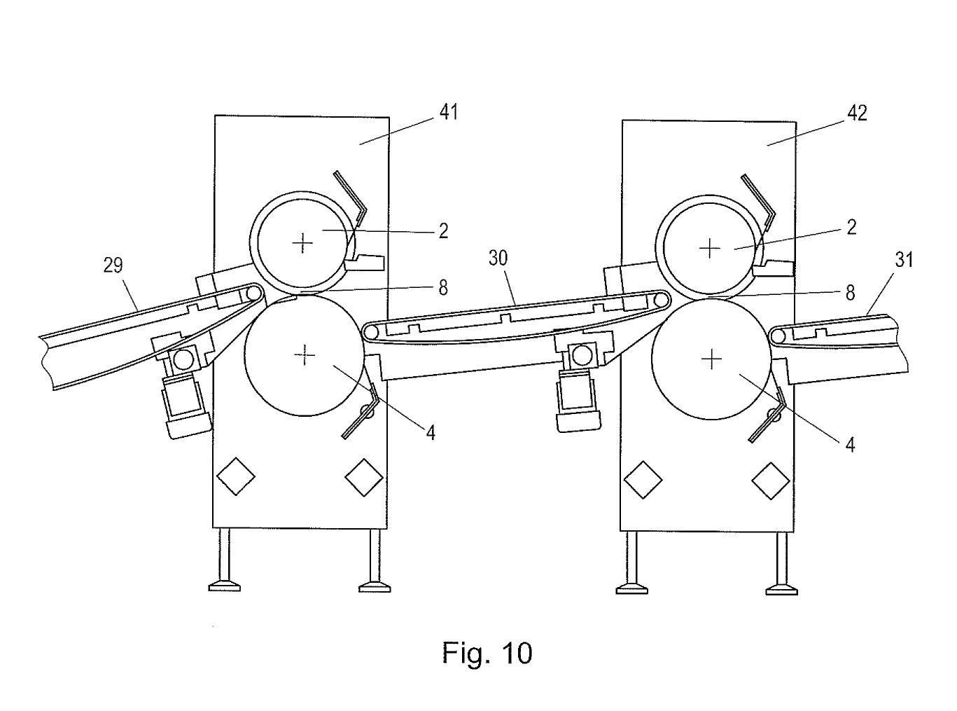

FIG. 10 shows an apparatus according to the invention with two roller pairs.

FIG. 1 shows an apparatus according to the invention comprising an upper roller 2 and a lower roller 4, where the upper roller 2 is mounted rotatably about a first axis of rotation 3 and the lower roller 4 is mounted rotatably about a second axis of rotation 5. Furthermore, the two rollers 2, 4 are driven or drivable by one or a plurality of drives 28. In the embodiment shown, the upper roller 2 has a smaller diameter than the lower roller. The first axis of rotation 3 and the second axis of rotation 5 run approximately parallel in the diagram. The axes can be inclined relative to one another by means of one or a plurality of adjusting devices 20. In the following embodiment, the upper roller 2 is mounted rotatably in the machine frame 19. In the rigid, preferably fixedly arranged, machine frame 19, a first bearing 11 and a second bearing 13 are provided for mounting the first shaft 9. The two bearings 11 and 13 are designed as rotary bearings. The position of the first bearing 11 is designated as first bearing point 10 and the position of the second bearing 13 is designated as second bearing point 12. The lower roller 4 is coupled to a second shaft 14 which is mounted on both sides of the lower roller in a third bearing 16 and a fourth bearing 18. The third bearing 16 is located at the third bearing point 15 and the fourth bearing 18 is located at the fourth bearing point 17. The bearing points 15 and 17 are movable according to the present embodiment by means of an adjusting device 20. To this end, the adjusting device 20 has an actuator 21. This is suitable and/or adapted for moving at least one bearing point.

A roller nip 8 is provided between the lower roller 4 and the upper roller 2. According to the present invention, the dough sheet 1 is guided through this roller nip. The roller nip 8 is determined in its size by the position of the upper roller 2 and the lower roller 4. This position can be varied, in particular by the adjusting devices 20. The separate adjustability of at least one bearing point, in particular the third bearing point 15 and/or the fourth bearing point 17, enables an inclination of the second axis of rotation 5 relative to the first axis of rotation 3. By actuating both actuating devices 20, a parallel displacement of the axes of rotation 3, 5 relative to one another can be achieved.

FIG. 2 shows a side view of an apparatus according to the invention as shown, for example, in FIG. 1. A dough sheet 1 is guided along a first conveying surface 29 in the region or direction of the roller nip 8. In the present embodiment the first conveying surface 29 is designed as a conveyer belt. The conveyer belt has a transfer edge which is disposed in a region remote from the roller nip 8. Between the first conveying surface 29 and the roller nip 8 there is provided a free region in which the dough sheet 1 is not guided. This dough sheet has a certain tensile strength and flexural rigidity. The dough sheet is held under tension and conveyed further by the turning of the rollers. To this end, the upper roller 2 and the lower roller 4 turn in opposite directions. Furthermore the upper roller has a smaller diameter than the lower roller. Both rollers are mounted in a machine frame 19. In the present embodiment of FIG. 1 and FIG. 2, the machine frame comprises laterally continuously running side plates which are preferably arranged in a fixed position. The upper roller 2 is in turn coupled to a first shaft 9 which is mounted on both sides on the machine frame 19 by means of a first bearing 11 and a second bearing 13. The second shaft 14 is coupled to the lower roller 4. This is in turn mounted on both sides on the machine frame 19 by means of a third bearing 16 and a fourth bearing 18. The third bearing 16 visible in the present diagram or the third bearing point 15 is movable by means of the adjusting device 20. To this end, a bearing block 32 is disposed displaceably in the machine frame 19. The displacement of the bearing block 32 is accomplished by means of the adjusting device or by means of the actuator 21. This is designed, for example, as a mechanical, pneumatic or electric actuator. It further has a direction of action which substantially corresponds to the degree of freedom of the bearing block 32. A gap 33 is provided to enable the displaceability. The degree of movement of the bearing block 32 in the machine frame 19 is crucially limited by the size of this gap 33.

The actuator 21 is fastened, for example, by means of an element on the machine frame 19. Another element which can be moved by the actuator with respect to the first element is connected to the bearing block 32. By actuating the actuator, a variation in the length of the same is effected. This can be converted by means of the coupling to the bearing block 32 into a longitudinal movement of the bearing block.

According to the invention, the dough sheet 1 is conveyed between the two rollers and thereby rolled out. This preferably brings about an at least partial thinning of the sheet. The apparatus is preferably configured in such a manner that resting of the dough sheet 1 on the lower roller 4 is favoured. When starting up the device, for example when introducing for the first time the dough sheet to be conveyed continuously, according to the invention the dough sheet adheres to the lower roller. A stripper 34 is provided to bring about a further conveyance of the dough sheet 1 to the second conveying surface 30.

The second conveying surface 30 is also configured, for example, as a conveyer belt. In the case of the thinning-out and rolling-out of a dough sheet 1, the dough sheet 1 has a lower speed in the region of the first conveying surface 29 than in the region of the second conveying surface 30. This is directly proportional to the cross sectional variation due to the guidance of the dough sheet 1 through the roller nip 8.

FIG. 3 shows a side view of a further embodiment of the apparatus according to the invention. An upper roller 2 and a lower roller 4 are mounted on a machine frame 19. The machine frame 19 comprises one or more adjusting devices 20. Preferably one adjusting device per side—i.e. two adjusting devices 20 in total—is provided. The adjusting device 20 is used in particular for positioning of the first axis of rotation 3 of the upper roller 2 with respect to or relative to the second axis of rotation 5 of the lower roller 4. In the present embodiment, the upper roller 2 and/or its first shaft 9 is mounted on both sides in the machine frame 19. For mounting, a first bearing 11 is provided at a first bearing point 10 and a second bearing 13 is provided at a second bearing point 12. In the present embodiment, the first and the second bearing point are coupled substantially fixedly to the machine frame.

In this embodiment also, the two rollers are driven rotatably about the respective axes of rotation by means of one or more drives 28. The drives 29 are not indicated in the present diagram.

The lower roller 4 is coupled to a second shaft 14. This is rotatably mounted on the one hand at a third bearing point 15 on a third bearing 16 and on the other hand at a fourth bearing point 17 on a fourth bearing 18. The fourth bearing 18 and the third bearing 16 are coupled to the machine frame 19. The coupling is achieved by means of an adjusting device 20 as in the previous embodiments. The adjusting device 20 here comprises a first pivot arm 22 which is connected pivotably about a first pivot axis 23 to the machine frame 19. A first pivot bearing 24 is provided for mounting of the pivot axis 23 in the machine frame 19. For example, the third bearing 16 of the lower roller 4 is provided on the first pivot arm.

According to the present embodiment, a second pivot arm 25 is provided. This is connected rotatably about a second pivot axis 26 to the machine frame 19 by means of a second pivot bearing 27 similarly to the first pivot arm. The fourth bearing 18 of the lower roller 4 is coupled to the second pivot arm 25.

In the present view, the pivot axis 26 runs substantially projecting. The actuator 21 is provided for turning of the pivot arm about the pivot axis. A turning of the pivot arm about the respective pivot axis can be achieved by means of a length variation of this actuator. For this purpose, the application point of the actuator 21 has a certain normal distance from the pivot axis of the pivot arm. Over the normal distance a linear movement of the actuator 21 can be converted into a rotation movement about the pivot axis. However it is also consistent with the inventive idea to arrange a rotational drive coaxially to the pivot axis. The third bearing point 15 of the third bearing 16 of the lower roller is disposed on the first pivot arm 22 at a certain normal distance from the pivot axis 23. A shift of the respective bearing point is thus accomplished through a turning of the pivot arm.

The situation is similar with the second pivot arm 25 on which the fourth bearing point 17 of the lower roller 4 is provided at a certain normal distance from the second pivot axis 26. A movement of the third bearing point 15 and/or the fourth bearing point 17 is thus made possible by actuation of the respective actuator 21. Another possibility for adjustment of the adjusting device 20 is made possible by a shifting of the pivot axes of the pivot arm.

One or two lugs 35 are connected to the machine frame 19, in particular to the base plate of the machine frame, for shifting of the pivot axis. The lugs 35 have openings for contact with an adjusting screw 36. In the present embodiment, the heads of the two adjusting screws 36 of the two lugs 35 project with respect to one another in the direction of a bearing block 32 of the pivot bearing. For this purpose the adjusting screws 36 are screwed with their thread into a threaded opening of the lugs 35. By turning the adjusting screws, their position can be varied. Through contact with the bearing block 32 of the pivot axis, the bearing block itself can also be shifted. As a result of the change in the position of the pivot axis for example, a crossing of the first axis of rotation 3 with respect to the second axis of rotation 5 is achieved. Alternatively to the provision of lugs and adjusting screws, the adjusting device can also comprise, for example, eccentrically disposed mountings.

FIG. 4 shows a view of the roller pair according to the invention in a usual installation position from above. An upper roller 2 having a first axis of rotation 3 and a lower roller 4 having a second axis of rotation 5 are mounted in a machine frame 19, where the first axis of rotation and the second axis of rotation run substantially parallel to one another. The first axis of rotation and the second axis of rotation can be inclined relative to one another by means of the movement of at least one bearing point. In the present embodiment, the second axis of rotation has a certain shift with respect to the first axis of rotation. This can be used, for example, to improve the favouring of resting of the dough sheet 1 on the lower roller. To this end, the axis of rotation of the lower roller is located upstream of the axis of rotation of the upper roller in the transport direction 37. The upper roller is therefore located downstream and the angle of emergence of the dough sheet from the roller nip 8 is inclined slightly downward in the direction of gravity.

FIG. 5 shows a schematic view of an upper roller 2 and a lower roller 4. The viewing direction substantially follows a perpendicular direction in the usual installation position or a direction which is substantially normal to the surface of the dough sheet in the roller nip. The first axis of rotation 3 of the upper roller and the second axis of rotation 5 of the lower roller are inclined relative to one another in the present view. In particular, the two axes exhibit a crossing. The inclination is configured geometrically in such a manner that in the image plane a projection axis exists which intersects both axes of rotation. The axis lies in the region of the roller nip and is substantially normal to the surface of the dough sheet in the region of the roller nip. In particular, the straight line runs through each point or through each region of the roller nip at which the two rollers 2, 4 have the smallest normal distance from one another. As a result of the crossing, in particular a sagging of the rollers under the pressure of the dough sheet to be rolled out is reduced. This has positive effects on the quality of the dough sheet produced. Furthermore, the dimensioning of the entire device can be or is improved as a result of the reduction of the pressure and the reduction of the sagging. Thus, as a result of the smaller sagging, it is possible to use smaller roller diameters. furthermore, the bearings 11, 13 and/or 16, 18 are less stressed due to smaller sagging.

FIG. 6 shows, similarly to FIG. 5, a view of an upper roller and a lower roller 4 but in a side view. The two roller are again crossed where the viewing axis of the view substantially follows the first axis of rotation 3 which runs projecting in this view. The two rollers and the two axes of rotation 3, 5 are inclined relative to one another and in particular crossed. Here, as in FIG. 5 also, the two axes are skew with respect to one another. In FIG. 6 the axes are disposed skew to one another in parallel planes. Thus, the first axis of rotation 3 lies in a first plane 38 and the second axis of rotation 5 lies in a second plane 39. In the present embodiment the two planes 38 and 39 are disposed parallel to one another. However, it is also consistent with the inventive idea that the planes are inclined to one another and have a line of intersection.

FIG. 7 shows a schematic sectional view along the line of intersection 40 from FIG. 3. To improve the clarity, the pivot axis is shown shortened. In the present embodiment 7, a substantially continuous pivot axis is provided which is formed by the first pivot axis 23 and the second pivot axis 26. However it is also completely consistent with the inventive idea to provide separate pivot axes which are not coupled to one another.

The first pivot axis 23 is mounted in a first pivot bearing 24. Furthermore the first pivot axis 23 is coupled to the first pivot arm 22. In the present embodiment, the coupling between the first pivot arm 22 and the first pivot axis 23 is designed as a rigid connection. The first pivot bearing 24 is designed as a rotary bearing. Furthermore the first pivot bearing 24 is movable and/or adjustable with respect to the machine frame 19. For this purpose, two lugs 35 are connected to the machine frame 19. Adjusting screws 36 project into the lugs 35, with the threaded shank thereof screwed into the threaded hole of the lug 35. By turning the screws, the position of the adjusting screws 36 can thus be varied relative to the respective lug 35. The heads of the adjusting screws 36 are coupled to the bearing 24 or a bearing block 32 surrounding the bearing 24. By adjusting the adjusting screws 36, the first pivot bearing 24 can thus be shifted. As a result of the variation of the position of the pivot bearing, the kinematics of the adjusting device and consequently the position and the positionability of the first axis of rotation 3 with respect to the second axis of rotation 5 also vary. The arrangement of the second pivot axis 26, the second pivot arm 25, the second pivot bearing 27 and the appurtenant adjusting screws 36 and the appurtenant lugs 35 substantially corresponds to the arrangement of the equivalent elements in the region of the first pivot bearing 24. In particular, the construction is substantially mirrored. Nevertheless, a separate adjustability of the position of the second pivot bearing 27 with respect to the machine frame 19 is made possible regardless of the position of the first pivot bearing 24 with respect to the machine frame 19. The pivot axis is designed as a continuous shaft, as noted. As a result of this arrangement, the roller nip can be achieved by means of a single actuator 21, as shown for example in FIG. 3.

However, it is also consistent with the inventive idea that the pivot axis is designed as a non-continuous shaft. In this case the first pivot axis 23 is separate from the second pivot axis 26. These have no coupling and are moveable independently of one another. By providing two actuators 21—one for the movement of the first pivot arm 22 and one for the movement of the second pivot arm 25—a complete decoupling of the two bearing points is thus made possible.

FIG. 8 shows two positions of the pivot axis or the pivot bearing with respect to the lugs 35 connected firmly to the machine frame.

FIG. 8a shows a substantially central base position where the pivot axis 23 and/or the first pivot bearing 24 is provided substantially centrally between the two lugs 35. In the threaded holes of the lugs 35 there are provided adjusting screws 36 whose screw heads clamp a bearing block 32 or which are connected to the bearing block 32. The pivot bearing 24 is mounted in the bearing block 32. By varying the position of the adjusting screws 36 with respect to the lugs 35, the bearing block, the pivot axis 23 and/or the pivot bearing 24 can be shifted.

For example, FIG. 8b shows the same arrangement in a second position. Here the bearing block is shifted to the right in the plane of the diagram. To this end the adjusting screw 16 shown on the right is inserted more deeply into the threaded hole of the right lug 35.

FIG. 8c shows another position where the bearing block 32, the first pivot axis 23 and/or the first pivot bearing 24 are shifted in the opposite direction to that in FIG. 8b. Shifting of the bearing block, the first pivot axis and/or the first pivot bearing 24 with respect to the appurtenant lugs 35 or with respect to the machine frame 19 brings about a variation in the kinematics of the adjusting device 20.

FIG. 9a shows a schematic view, in particular a schematic side view, of the apparatus according to the invention comprising an upper roller 2, a lower roller 4 and a dough sheet 1. The dough sheet 1 is shown schematically. According to the invention this preferably comprises an endless dough sheet, in particular for forming shaped bodies for the industrial production of biscuits. In the position in FIG. 9a, the upper roller 2 is arranged at a distance from the lower roller 4 so that the roller nip 8 has a gap width which is greater than the thickness of the dough sheet guided therethrough. This position corresponds, for example, to the introduction of the dough sheet at the beginning of the rolling process. For this purpose the unrolled dough sheet is conveyed along the first conveying surface 29 in the direction of the roller nip 8, where the conveying surface 29 ends at a certain distance upstream of the roller pair. Between the roller nip 8 and the end of the first conveying surface 29, the dough sheet is thus arranged freely sagging or tensioned between the two elements. According to the present invention, the dough sheet 1 adheres to the lower roller 4. Subsequently the dough sheet 1 is to be conveyed further along a second conveying surface 30. The second conveying surface 30 also has a certain distance from the roller nip and/or from the lower roller 4. In order to lead the front end of the dough sheet onto the second conveying surface 30 when starting up the device, a stripper 34 is provided. This stripper substantially corresponds to a plate-shaped body which can be folded or is folded onto the lower roller 4. The stripper 34 is arranged in a substantially fixed position and/or is connected to the machine frame 19. The dough sheet 1 is released from the lower roller by the stripper. As a result of further dynamic effects, the dough sheet 1 comes in contact with the second conveying surface 30 and is transported further by this conveying surface.

FIG. 9b shows, for example, the same view as FIG. 9a, but in continuous operation. In the present view, the endless dough sheet is again shown schematically torn off. According to the invention however, this comprises an endless dough sheet. Again, the dough sheet is located on the one side on the first conveying surface 29 and on the other side on the second conveying surface 30. The roller pair comprising an upper roller 2 and a lower roller 4 is located between the two conveying surfaces. In continuous operation the stripper is not in engagement with the dough sheet 1. On the contrary, the dough sheet is pulled by the second conveying surface 30 from the lower roller 4. For this purpose, the speed of the dough sheet 30 substantially corresponds to the peripheral speeds of the rollers. The conveying speed of the first conveying surface 29 is in this case lower than the conveying speed of the second conveying surface. This results from the fact that the dough sheet experiences a reduction in the cross-sectional area in the roller nip 8 for the same volume flow. As a result of this thinning, for continuous conveyance the dough sheet 1 must have a higher speed after the roller nip 8 than before the roller nip.

Preferably, resting on the lower roller is favoured by the upper roller having a higher circumferential speed than the lower roller. Furthermore a shift of the first axis of rotation 3 with respect to the second axis of rotation 5 is given in FIGS. 9a and 9b. The first axis of rotation 3 is thus disposed in the transport direction of the dough sheet 1 upstream of the second axis of rotation 5. This configuration can also help to promote a resting of the dough sheet on the lower roller.

FIG. 10 shows an arrangement of several apparatuses according to the invention according to the preceding description. In order to form a flat-rolled, continuously conveyed dough sheet, it may be necessary to perform the rolling in several steps. For this purpose the dough sheet is supplied via a first conveying surface to a first device 41. This comprises, according to the preceding description, an upper roller 2, a lower roller 4 and a roller nip 8 provided between the two rollers. The dough sheet is guided through the roller nip 8 onto a second conveying surface 30. The conveying surface 30 conveys the endless dough sheet 1 further to a second device 42 which is also constructed according to the previous description. This also comprises an upper roller 2, a lower roller 4 and a roller nip 8 disposed between the two rollers. For this purpose the roller nip 8 of the second device 42 has a smaller gap width than the roller nip 8 of the first device 41. In particular, the normal distance between the upper roller 2 and the lower roller 4 of the second device 42 is smaller than the normal distance of the upper roller 2 and the lower roller 4 of the first device 41. As a result of thinning of the dough sheet, for optimal conveyance a higher conveying speed is required after the roller pair than before the roller pair. In particular this means that when two devices 41, 42 are provided, the circumferential speeds of the lower roller and the upper roller of the second device 42 are higher than the circumferential speeds of the upper roller and the lower roller of the first device 41. Preferably the two devices 41, 42 are arranged in series along the transport direction of the dough sheet 1. A third conveying surface 31 is provided downstream of the second device 42. For high-quality formation of the dough sheet, the dough sheet is rolled in two stages from an initial thickness to a final thickness.

According to the invention, a third device can also be provided. This is also arranged similarly to the arrangement shown in FIG. 10 in series being the second device 42. The thinning of the dough sheet can thus take place in three steps.

In order to produce the endless dough sheet for the industrial production of biscuits, preferably at least two devices are arranged consecutively in series.

The two devices 41, 42 preferably have the same structure. The respective roller nips are adjustable by means of the respective adjusting devices. In particular, the roller nip 8 of the first device 41 has a greater gap width than the roller nip 8 of the second device 42. The roller nip of a third device has a smaller gap width than the two preceding devices.

As an exemplary embodiment, the first device has a transport speed of 2 m/min up to 8 m/min with a gap width of 5 mm to 20 mm.

The second device, for example has a conveyer belt speed of about 4 m/min up to 16 m/min with a gap width of 3 mm up to 10 mm.

A third device located therebehind has a speed of, for example, 8 m/min up to 32 m/min with a gap width of 0.5 mm to 3 mm.

Optionally a fourth device can also be provided in which the dough sheet has a speed of about 16 m/min up to 50 m/min.

Typical speeds for an arrangement according to the invention are, for example, about 6 m/min in the first device, 12 m/min in the second device and 25 m/min in the third device.

The respective gap widths and speeds can be adapted individually in each individual device. The adaptation is particularly influenced by parameters such as the dough consistency and the gap width or the thickness of the dough sheet. The rollers, for example have a diameter of about 250 to 450 mm.

The different embodiments of the apparatus according to the invention are exemplary embodiments to illustrate the basic idea of the invention. In this case different features of one embodiment can be combined with features of another embodiment. Thus, for example the embodiment of FIGS. 1 and 2 can also be used with a substantially linear moveable bearing block in an arrangement of several devices as shown in FIG. 10. The embodiments of FIGS. 3 and 4 can also be designed, for example, as an arranged according to FIG. 10. Furthermore the arrangement of the drives from FIG. 1 is also possible on the device according to FIG. 3.

### REFERENCE LIST

1. Dough sheet
2. Upper roller
3. First axis of rotation
4. Lower roller
5. Second axis of rotation
6. Direction of rotation of upper roller
7. Direction of rotation of lower roller
8. Roller nip
9. First shaft
10. First bearing point
11. First bearing
12. Second bearing point
13. Second bearing
14. Second shaft
15. Third bearing point
16. Third bearing
17. Fourth bearing point
18. Fourth bearing
19. Machine frame
20. Adjusting device
21. Actuator
22. First pivot arm
23. First pivot axis
24. First pivot bearing
25. Second pivot arm
26. Second pivot axis
27. Second pivot bearing
28. Drive
29. First conveying surface
30. Second conveying surface
31. Third conveying surface
32. Bearing block
33. Gap
34. Stripper
35. Lug
36. Adjusting screw
37. Transport direction
38. First plane
39. Second plane
40. Line of intersection
41. First device
42. Second device

1-22. (canceled)

23. An apparatus for forming a flat-rolled continuously conveyed dough sheet, the apparatus comprising:
an upper roller driven rotationally about a first axis of rotation and with a given direction of rotation;
a lower roller driven rotationally about a second axis of rotation and with a direction of rotation opposite the given direction of rotation of said upper roller;
said upper and lower rollers being disposed to formed a roll nip in between for guiding through and rolling out the dough sheet;
said upper and lower rollers having a configuration which favors resting of the dough sheet on said lower roller; and
said first and second axes of rotation can be inclined relative to one another.

24. The apparatus according to claim 23, wherein a diameter of said upper roller is smaller than a diameter of said lower roller.

25. The apparatus according to claim 23, wherein said upper roller is driven with a higher circumferential speed than said lower roller.

26. The apparatus according to claim 23, wherein said rollers are disposed to enable said axes of rotation to extend parallel or skewed with respect to one another, or to optionally have no point of intersection or a common point of intersection.

27. The apparatus according to claim 23, which comprises first and second bearings formed as radial bearings, and wherein said upper roller, or a first shaft coupled to said upper roller, is mounted at a first bearing point on said first bearing and at a second bearing point on said second bearing.

28. The apparatus according to claim 27, which comprises third and fourth bearings formed as radial bearings, and wherein said lower roller, or a second shaft coupled to said lower roller, is mounted at a third bearing point on said third bearing and at a fourth bearing point on said fourth bearing.

29. The apparatus according to claim 28, wherein said bearings are mounted to a machine frame.

30. The apparatus according to claim 28, which comprises at least one adjusting device configured to move at least one said bearing point relative to the respectively other said bearing points.

31. The apparatus according to claim 28, wherein one or both said bearing points of one of said first and second rollers are movable.

32. The apparatus according to claim 30, wherein said at least one adjusting device comprises an electrical or mechanical actuator for inclination of said axes of rotation and for movement of at least one said bearing point.

33. The apparatus according to claim 30, wherein said at least one adjusting device is adapted for movement of at least one said bearing point with respect to a machine frame or with respect to the remaining said bearing points.

34. The apparatus according to claim 30, wherein said at least one adjusting device comprises a bearing block firmly connected to a bearing or a bearing point which is movable substantially linearly by an actuator with respect to a machine frame and/or with respect to another bearing point.

35. The apparatus according to claim 30, wherein said at least one adjusting device comprises a first pivot arm pivotally mounted about a first pivot axis to a machine frame, with one of said bearing points and a corresponding said bearing being disposed on said first pivot arm, and wherein said first pivot arm and said bearing point provided on said first pivot arm are movable by way of a first actuator.

36. The apparatus according to claim 35, wherein said first pivot arm is mounted to the machine frame by way of a first pivot bearing and a position of said first pivot bearing relative to the machine frame is variable.

37. The apparatus according to claim 35, wherein said at least one adjusting device comprises a second pivot arm pivotally mounted about a second pivot axis to the machine frame, with one of said bearing points and a corresponding said bearing being disposed on said second pivot arm, and wherein said second pivot arm and said bearing point provided on said second pivot arm are movable by way of a second actuator.

38. The apparatus according to claim 37, wherein said second pivot arm is mounted to the machine frame by way of a second pivot bearing and a position of said second pivot bearing relative to the machine frame is variable.

39. The apparatus according to claim 37, wherein a movement of said bearing or bearing points provided in said pivot arms causes said axis of rotation of one said roller to be inclined with respect to said axis of rotation of the respectively other said roller.

40. A configuration for forming a flat-rolled, continuously conveyed dough sheet, comprising two or more apparatus according to claim 23 disposed along the dough sheet.

41. The configuration according to claim 40, characterized in that the gap width of at least one roller nip of one device is smaller than the gap width of a downstream device in the direction of transport of the dough sheet.

42. The configuration according to claim 40, characterized in that the adjusting devices of the individual devices are controllable and/or movable separately from one another.

43. The configuration according to claim 40, characterized in that a control unit is provided for controlling the drives, the conveyance along the conveying surfaces and/or the adjusting devices.

44. The configuration according to claim 40, characterized in that the control unit is connected to a control unit of the baking machine or that one control unit is provided for controlling the arrangement and the baking machine.
